(19) United States
(12) Patent Application Publication
(10) Pub. No.: US 2018/0096444 A1
(43) Pub. Date: Apr. 5, 2018

(54) METHOD AND APPARATUS FOR MANAGING TRAINING RESOURCES

(71) Applicant: AT&T INTELLECTUAL PROPERTY I, L.P., Atlanta, GA (US)

(72) Inventors: NIGEL BRADLEY, McDonough, GA (US); TIMOTHY INNES, Atlanta, GA (US); WASIB KHALLIL, Atlanta, GA (US); ALEXANDER MACDOUGALL, Newnan, GA (US); BHUMIT PATEL, Atlanta, GA (US)

(21) Appl. No.: 15/284,143

(22) Filed: Oct. 3, 2016

(51) Int. Cl. G06Q 50/20

(52) U.S. Cl. CPC G06Q 50/2057

(57) ABSTRACT

Aspects of the subject disclosure may include, for example, a method including receiving a description of a work assignment; the description includes a keyword. The method also includes searching online content for training material related to the work assignment, and searching the online content for information regarding the training material; at least a portion of the training material is accessible via a website. The method also includes assigning a credibility ranking to the website; compiling a training material ranking in accordance with the information and the website credibility ranking; and generating a training program for performing the work assignment, based on the training material and the training material ranking. Training program data for facilitating access to the training program is stored in a database indexed using the keyword. Other embodiments are disclosed.

### FIELD OF THE DISCLOSURE

The subject disclosure relates to a method and apparatus for managing training resources.

### BACKGROUND

The Internet has fostered a peer-to-peer model for shared access to goods and services. This model extends to the employment marketplace, in which workers with specialized skills perform short-term assignments for a variety of employers (sometimes also called the ‘gig economy’). Job seekers in the gig economy frequently seek training and/or mentoring to better prepare themselves for a new assignment.

### BRIEF DESCRIPTION OF THE DRAWINGS

Reference will now be made to the accompanying drawings, which are not necessarily drawn to scale, and wherein:

FIG. 1 schematically illustrates a system for searching job training resources, job seeking, job posting, evaluation and mentoring, in accordance with embodiments of the disclosure;

FIG. 2 schematically illustrates a system for automated searching and compilation of training resources related to a job posting, in accordance with an embodiment of the disclosure;

FIG. 3 is a flowchart illustrating a method in which training programs for a posted job are compiled, vetted and customized, using the system of FIG. 2;

FIG. 4 is a flowchart illustrating a method in which a job seeker's training program and job performance are evaluated, in accordance with embodiments of the disclosure;

FIG. 5 schematically illustrates a system for facilitating mentoring of a job seeker, in accordance with embodiments of the disclosure;

FIG. 6 is a flowchart illustrating a method in which a mentoring process for a job seeker is evaluated, using the system of FIG. 5;

FIG. 7 schematically illustrates a system for facilitating matching a job seeker's location with locations of available jobs, in accordance with embodiments of the disclosure;

FIG. 8 is a flowchart illustrating a method in which a job seeker's location is traced and predicted, using the system of FIG. 7;

FIG. 9 is a flowchart illustrating a method in which locations of jobs are mapped and matched with a job seeker's location, using the system of FIG. 7;

FIGS. 10 and 11 depict illustrative embodiments of communication systems that can be used by job seekers, job posters, and mentors in performing the methods of FIGS. 3, 4, 6, 8 and 9;

FIG. 12 depicts an illustrative embodiment of a web portal for interacting with the communication systems of FIGS. 10 and 11;

FIG. 13 depicts an illustrative embodiment of a communication device; and

FIG. 14 is a diagrammatic representation of a machine in the form of a computer system within which a set of instructions, when executed, may cause the machine to perform any one or more of the methods described herein.

### DETAILED DESCRIPTION

The subject disclosure describes, among other things, illustrative embodiments for identifying training and mentoring resources for use in specific work assignments. Other embodiments are described in the subject disclosure.

One or more aspects of the subject disclosure include a method including receiving, by a processing system including a processor, a description of a work assignment; the description includes a keyword. The method also includes searching online content for training material related to the work assignment, and searching the online content for information regarding the training material including a cost of the training material, trainee reviews, client reviews, and/or accreditations; at least a portion of the training material is accessible via a website. The method also includes assigning a credibility ranking to the website; compiling a training material ranking in accordance with the information and the website credibility ranking; and generating a training program for performing the work assignment, based on the training material and the training material ranking. The method further includes storing training program data for facilitating access to the training program in a training program database, where the training program database is indexed using the keyword.

One or more aspects of the subject disclosure include a device comprising a processing system including a processor and a memory that stores executable instructions that, when executed by the processing system, facilitate performance of operations. The operations include receiving a description of a work assignment, the description including a keyword; searching online content for training material related to the work assignment; and searching the online content for information regarding the training material including a cost of the training material, trainee reviews, client reviews, and/or accreditations; at least a portion of the training material is accessible via a website. The operations also include assigning a credibility ranking to the website; compiling a training material ranking in accordance with the information and the website credibility ranking; and generating a training program for performing the work assignment, based on the training material and the training material ranking. The operations also include storing training program data for facilitating access to the training program in a training program database, where the training program database is indexed using the keyword. The description of the work assignment includes information regarding requirements for performing the work assignment, and the information regarding the requirements includes an identifier of the training program.

One or more aspects of the subject disclosure include a machine-readable storage medium comprising executable instructions that, when executed by a processing system including a processor, facilitate performance of operations. The operations include receiving a description of a work assignment, where the description includes a keyword; searching online content for training material related to the work assignment; and searching the online content for information regarding the training material including a cost of the training material, trainee reviews, client reviews, and/or accreditations, at least a portion of the training material is accessible via a website. The operations also include assigning a credibility ranking to the website; compiling a training material ranking in accordance with the information and the website credibility ranking; compiling the training material ranking further includes receiving survey data regarding previous use of the training material. The operations further include generating a training program for performing the work assignment, based on the training material and the training material ranking, and storing training program data for facilitating access to the training program in a training program database; the training program database is indexed using the keyword.

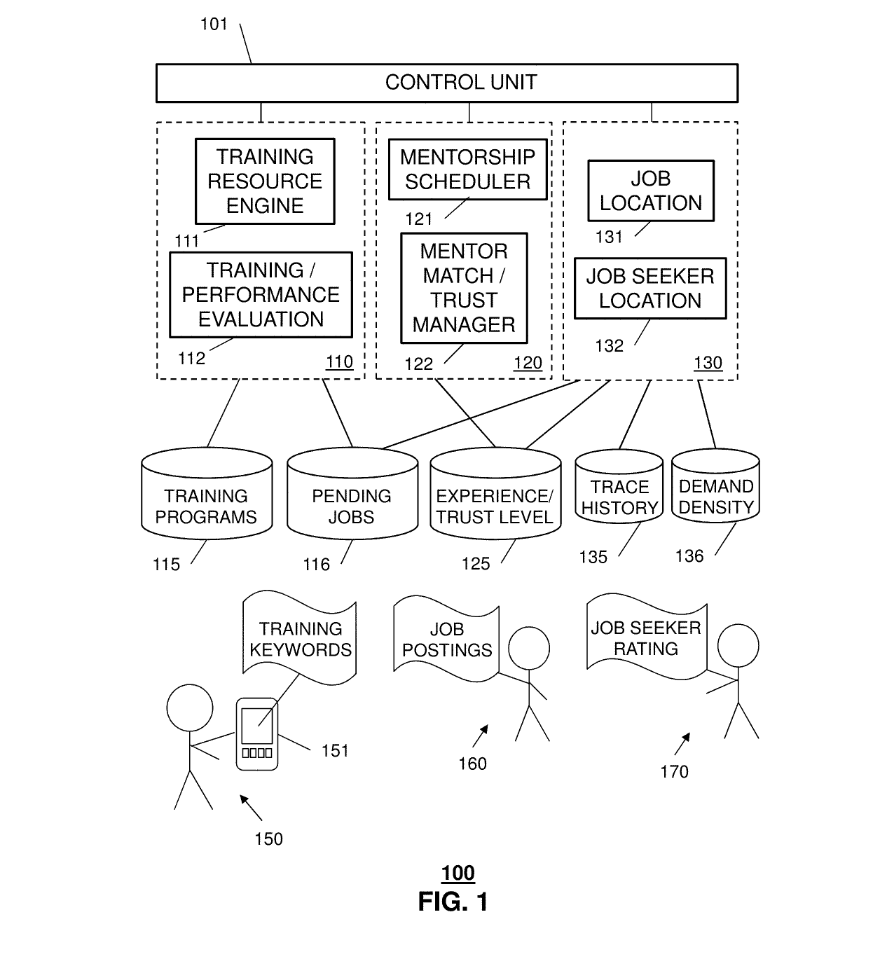

FIG. 1 schematically illustrates a system 100 in accordance with embodiments of the disclosure. System 100 comprises a control unit 101 for controlling various functions, including building job training programs and evaluating job performance 110, coordinating mentoring activities 120, and mapping and matching job seeker locations with job locations 130. As shown in FIG. 1, system 100 includes a training resource engine (TRE) 111; a system 112 for evaluating job seeker training and job performance; a mentorship scheduler 121; a system 122 for matching job seekers with mentors, including a trust manager for processing mentors' evaluation of job seekers; a system 131 for mapping locations of available jobs; and a system 132 for tracing and predicting the locations of job seekers who may be interested in those jobs.

Control unit 101 also communicates with a training programs database 115, a database 116 of pending jobs, an experience/trust level database 125 regarding job seekers' qualifications, a trace history database 135 having an archive of a job seeker's past locations, and a demand density database 136 for mapping the density of available jobs (workforce demand) in a geographical area of interest to the job seeker.

Users of the system 100 can include a job seeker 150, a job poster 160, and a mentor 170. In an embodiment, job seeker 150 uses a mobile communication device 151 (e.g. a smartphone, tablet, etc.) to input keywords to the control unit 101; the keywords indicate the type of work and/or the type of training the user is seeking. Job poster 160 (who needs a job done, and is potentially the employer of job seeker 150 on the next gig) inputs job postings to the control unit 101. Mentor 170, with whom the job seeker 150 can hold mentoring sessions scheduled using control unit 101, inputs feedback from the mentoring sessions, including a rating for the job seeker, to the control unit 101.

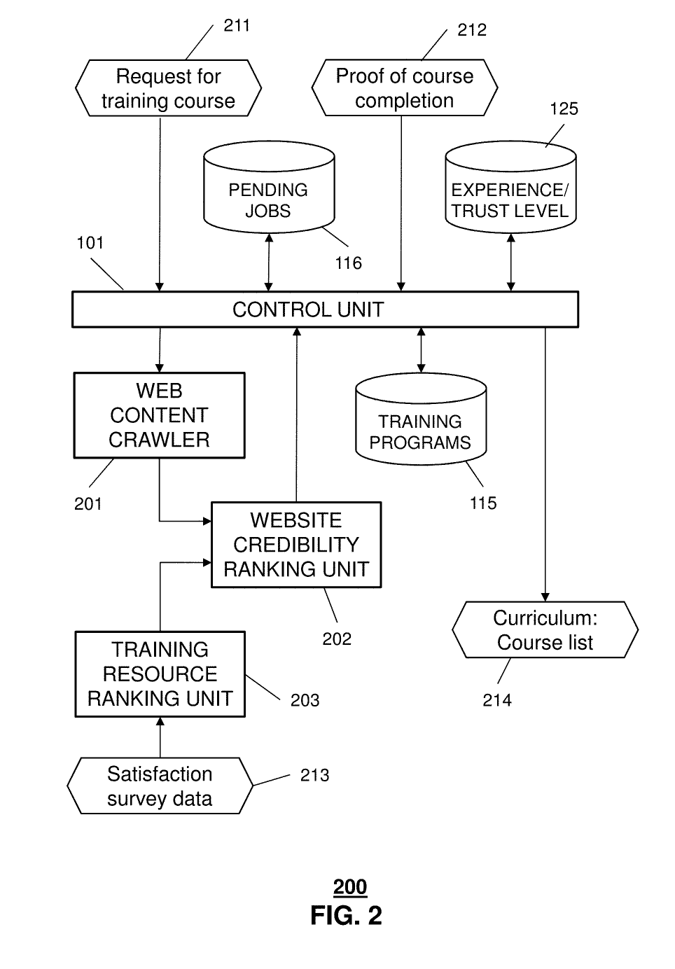

FIG. 2 schematically illustrates a embodiment 200 that includes the training resource engine (TRE) 111. The TRE can automatically generate a curriculum (a set of courses) for a requester (generally a job seeker 150), offering the requester training lessons focused on a subject of interest. As shown in FIG. 2, the TRE uses a web content crawler 201 to search for appropriate training materials that support a keyword or phrase inputted in a request 211.

Training resources previously used by job seekers can be evaluated using satisfaction surveys. Data 213 from these surveys is input to a training resource ranking unit 203 to identify those resources with the greatest utility; that is, the best past record of assisting job seekers (students) to build a new area of expertise.

Content returned by the web crawler 201 typically includes one or more websites (or links to those websites). In general, these websites offer content (e.g. training lessons) of varying quality, depending on numerous factors including relevance of the training, breadth and depth of treatment of the subject, effectiveness, and cost. A website credibility ranking unit 202 can use predefined rules and machine learning techniques to rank the websites.

Identifiers of the ranked resources, including the ranked websites, are returned to the control unit 101, which then functions as a curriculum builder. In this embodiment, the control unit 101 outputs a list 214 of courses for the requester (job seeker) to complete. The training program thus constructed in response to request 211 can be stored in the training programs database 115.

After a job seeker completes the curriculum, s/he can submit a proof of completion 212 to the control unit 101, which then updates an entry for the job seeker in the experience/trust level database 125. If the job seeker then submits an inquiry expressing interest in a posted job, the control unit can retrieve information regarding the job from the jobs database 116, retrieve information regarding the job seeker's training and experience from database 125, and determine whether the job seeker is suitable for that job.

In another embodiment, a job poster 160 can submit a job posting that includes one or more keywords, with a request that the TRE construct a training program appropriate to the posted job. A job seeker 150 can then retrieve that training program from the database 115 by submitting a request including the keywords.

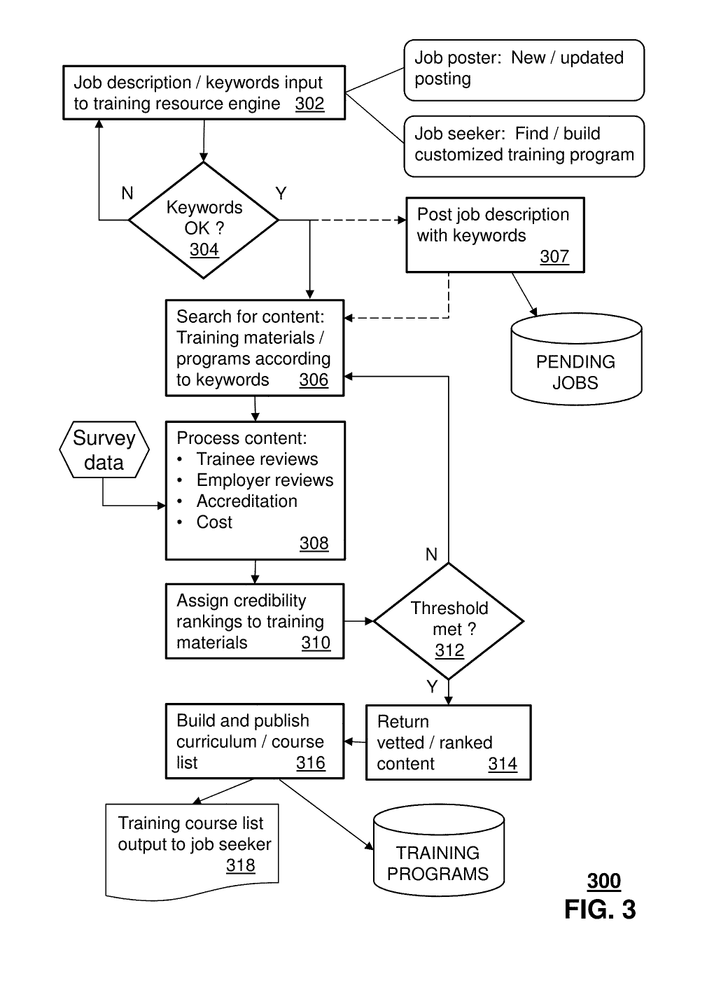

FIG. 3 depicts an illustrative embodiment of a method 300 for building a training course using the TRE of FIG. 2. In step 302, a job description (which may include keywords) is input to the TRE. This input may be made by a job poster 160 describing a new (or updated) available job, or by a job seeker 150 wishing to pursue a training program which will qualify him/her for that type of work. In an embodiment, the input to the TRE can include additional qualifiers such as the location and time of a work assignment, a deadline for completing the work assignment, etc. In an embodiment, the TRE includes a language processor for extracting keywords from a job description input by the job poster.

The TRE determines whether the keywords accurately define a subject area (or accurately reflect the inputted job description) and thus can serve as a basis for a content search (step 304). In this embodiment, a web content crawler 201 performs a search of publicly available (free-of-charge) online content (step 306) for training materials based on the keywords. In other embodiments, private and/or subscription databases (paid-access content) can be searched, instead of or in addition to searching the publicly available online content. In an embodiment where the job poster 160 submits the job description and keywords, the job description and keywords are posted and added to the jobs database (step 307).

The content returned by the web crawler 201 is then processed (step 308) to evaluate its quality (relevance, effectiveness, cost, etc.). In this embodiment, training materials returned by the web crawler are evaluated and vetted using reviews previously submitted by trainees and employers. Results of satisfaction surveys can also be used to determine the utility/credibility of a given training resource. In addition, the TRE can determine the accreditation status of a training course offered through a website.

The training resources can be assigned credibility ratings, which are then are assigned rankings (step 310) and compared with a threshold (step 312). For example, only the five highest-ranked training courses might be returned by the evaluation/vetting process. Training resources meeting the threshold (step 314) are then used to build a curriculum (step 316). In an embodiment, the curriculum can be built by selecting training material offered for purchase, based on rankings from evaluations of publicly available portions of training material; such a curriculum utilizes a wider range of content than that available free of charge, while offering cost efficiency since the paid-access training material has been vetted by the TRE. In another embodiment, the curriculum is tailored to a particular work assignment, and can include text and/or images pertaining to that work assignment; the text and images can be provided by the job poster. The curriculum (generally including a course list) is saved in the training programs database. In an embodiment where the TRE builds a curriculum in response to a job seeker's inquiry, the course list is delivered to the job seeker (step 320); for example, the course list can be outputted to a display on the job seeker's mobile device 151. In an embodiment, delivery of the curriculum is location-dependent and/or time dependent; for example, the curriculum can be delivered only if the job seeker is located within a predetermined distance of the work assignment, and/or a predetermined time interval in advance of the starting time of the work assignment.

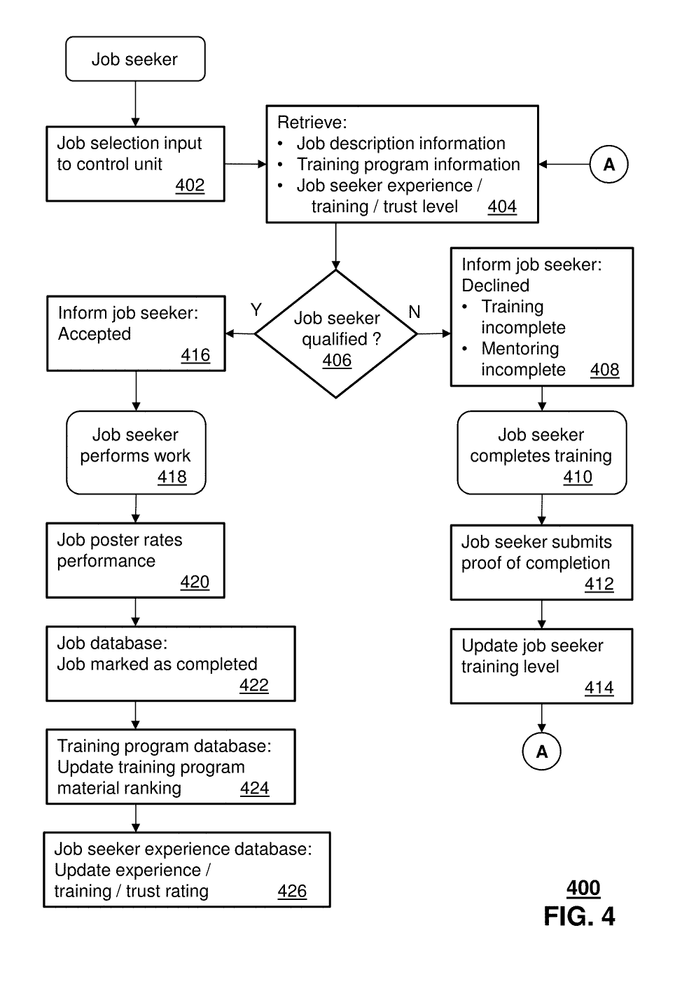

FIG. 4 depicts an illustrative embodiment of a method 400 in which a job seeker completes a training program relating to a job, and whose performance is then evaluated. In step 402, a job seeker selects a posted job; in an embodiment, this is done by inputting keyword(s) to the control unit. In another embodiment, the job seeker may input an identifier or tag for the work assignment provided by the job poster. The control unit then retrieves (step 404) the job description from the jobs database 116, the training program associated with the job from the training program database 115, and information regarding the job seeker's experience, training, and/or trust level from database 125. The control unit then determines (step 406) whether the job seeker has the required experience and training, and/or has reached the required trust level, to perform the work. In an embodiment, the job seeker is determined to be qualified to perform the work if s/he has provided proof of completion of the training program.

If the job seeker is not yet qualified, the control unit informs the job seeker (step 408). In this embodiment, the control unit also provides a list of training materials not completed, and/or mentoring sessions still needed to gain the required trust level. After the job seeker completes the training and/or mentoring sessions (step 410), the job seeker can submit proof of completion (step 412) to the control unit. The control unit then can update the job seeker's work credentials (including experience, training and trust level) in database 125. The job seeker can then be sent a message inviting him/her to input a new job selection. In an embodiment, the job seeker's previous selection (applying for the work assignment) is automatically re-submitted upon the job seeker's submitting proof of completion. In another embodiment, if the originally posted job is no longer available and/or a predetermined length of time has passed (e.g. five days), the job seeker can be sent a message inviting him/her to apply for recently posted jobs associated with the same or similar keywords.

If the job seeker is determined to be qualified, the control unit informs the job seeker (step 416). The job seeker (who now becomes a contractor/employee) performs the work assignment (step 418). After the work is completed, the job poster (employer) rates the job seeker's performance (step 420). The job poster can inform the control unit that the work has been completed; the job is then marked as completed in the job database (step 422).

Based on the employer's evaluation of the work performed, the effectiveness of the training program can be re-evaluated; the ranking or credibility rating of the training program can accordingly be updated in the training program database (step 424). The experience/training/trust level database is also updated to reflect the employee's performance (step 426).

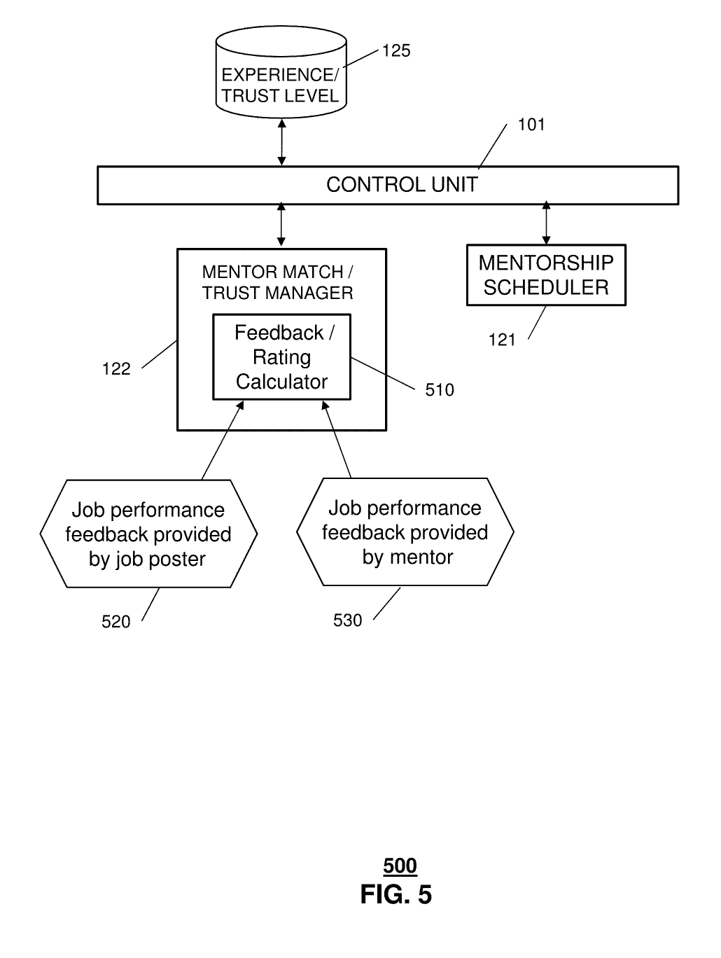

FIG. 5 schematically illustrates a system 500 for facilitating mentoring of a job seeker, in accordance with embodiments of the disclosure. As shown in FIG. 5, control unit 101 communicates with a mentor matching unit 122 that includes a trust manager, a mentorship scheduling unit 121, and the experience/training/trust level database 125. The mentor matching unit can match a mentor with a job seeker (mentee) based on the type of training desired, the mentee's experience, training and/or trust level, the mentor's and mentee's locations, etc. The mentorship scheduler can arrange mentoring sessions based on the mentor's and mentee's calendars.

The trust manager updates the mentee's trust level in database 125, based on the mentoring sessions and the mentee's job performance, rated by the job poster and the mentor. In this embodiment, the trust manager includes a feedback/rating calculator 510. Inputs to the feedback/rating calculator can include job performance feedback 520 provided by the job poster (that is, the mentee's employer) and job performance feedback 530 provided by the mentor.

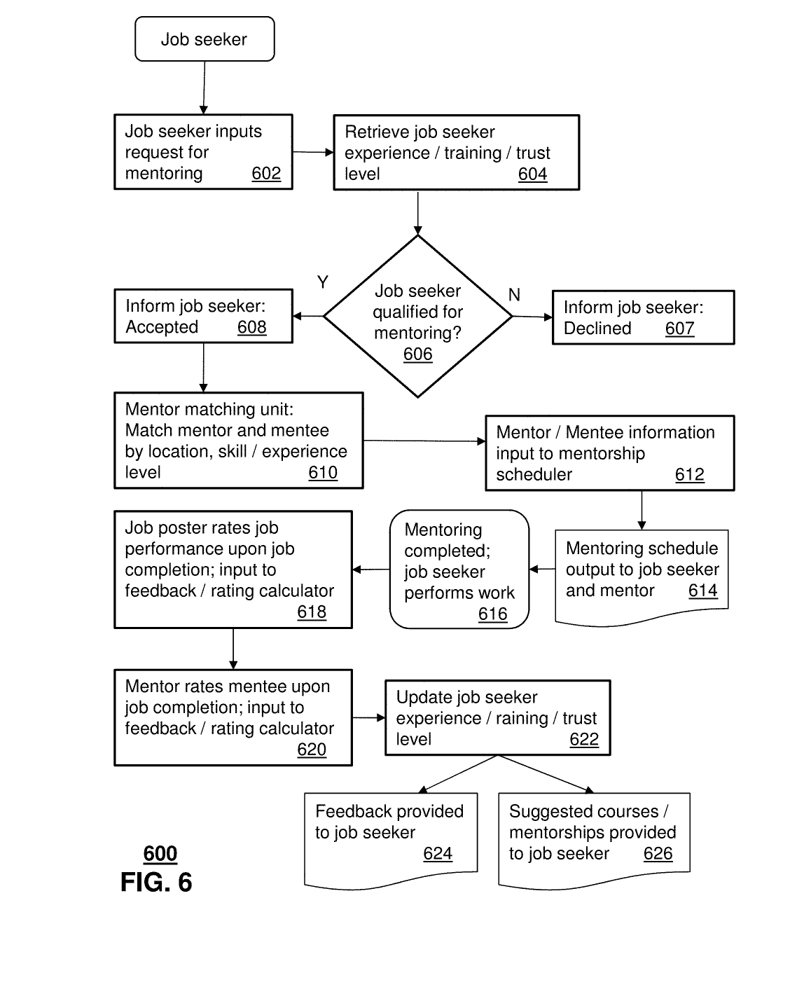

FIG. 6 depicts an illustrative embodiment of a method 600 for arranging and conducting mentoring sessions. In step 602, the job seeker inputs a request to the control unit 101 for mentoring. The control unit retrieves the job seeker's experience/training/trust level from the database 125 (step 604), and determines whether the job seeker is qualified for mentoring (step 606). In an embodiment, a job seeker is required to attain a prescribed trust level before mentoring sessions can be scheduled. If the job seeker is not approved for mentoring, the job seeker is informed by the control unit (step 607).

If the job seeker is approved for mentoring, the job seeker (mentee) is informed (step 608), and the mentor matching unit matches the mentor and mentee based on their locations and the mentee's current skill and experience level (step 610). Information regarding the mentor/mentee pair is then input to the mentorship scheduling unit (step 612), which generates a schedule of mentoring sessions and outputs the schedule to the job seeker and the mentor (step 614).

After the mentoring is completed, the job seeker performs a work assignment (step 616). In an embodiment, the mentor can send a message to the control unit, certifying that the mentoring sessions have been completed and that the job seeker is thus qualified for the work assignment. In this embodiment, the trust manager automatically updates the database 125 to reflect completion of the mentoring sessions.

The job poster (that is, the mentee's employer for the work assignment) evaluates the mentee's job performance and makes an input 520 to the feedback/rating calculator 510 (step 618). In this embodiment, the mentor also evaluates the mentee's job performance and makes an input 530 to the feedback/rating calculator 510 (step 620). The feedback/rating calculator 510 determines how the trust manager should adjust the trust level of the mentee; the mentee's trust level is then updated in the database 125 (step 622). Depending on the mentee's job performance, the trust level may be adjusted either up or down.

The feedback from the job poster and the mentor are provided to the mentee (step 624). The mentee is also provided with suggestions regarding additional courses or mentoring to increase his/her trust level (step 626).

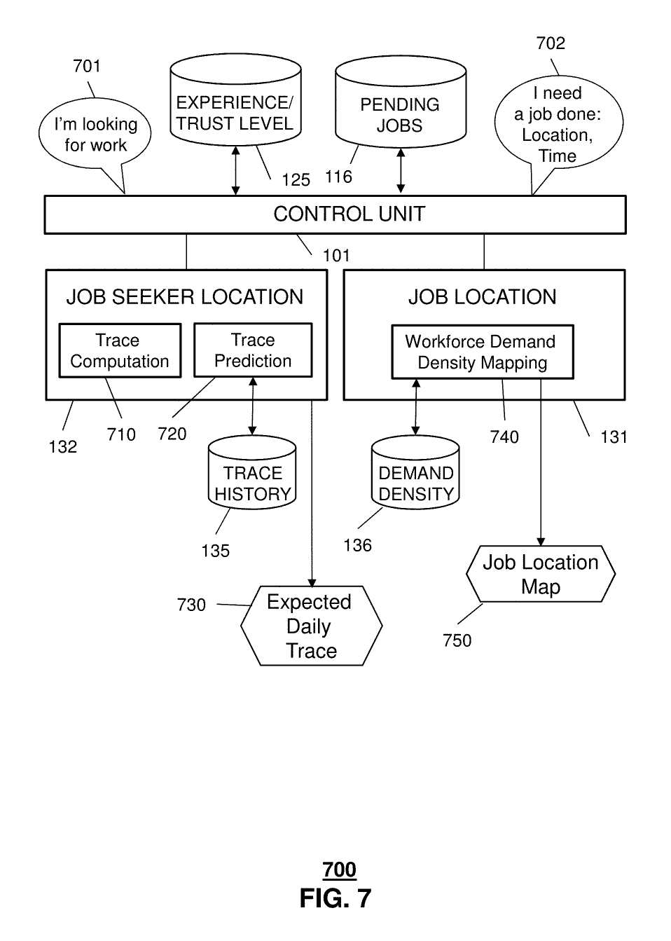

FIG. 7 schematically illustrates a system 700 for tracking supply and demand in the employment marketplace, thereby facilitating matching a job seeker with an available job, in accordance with embodiments of the disclosure. As shown in FIG. 7, control unit 101 communicates with job seeker location unit 132 that includes a trace computation unit 710 and a trace prediction unit 720. Control unit 101 also communicates with job location unit 131 that includes a workforce demand density mapping unit 740, and with the experience/training/trust level database 125, the jobs database 116, the trace history database 135, and the workforce demand density database 136.

The job seeker location unit 132 can trace a job seeker's location throughout a convenient time period (e.g. one day), predict the job seeker's location for a given time of day, and generate an expected daily trace 740 of the job seeker's movements. The job location unit 131 can generate a map 750 of available jobs within a convenient distance (e.g. ten miles) of the job seeker's current location or predicted location. In an embodiment, the job location map can be presented as a density of demand for workers.

In this embodiment, a job seeker 150 signs on to system 700 and indicates 701 that s/he is seeking a work assignment. A job poster also signs on to the system and indicates at 702 that s/he needs a job done; the posting typically includes the location and starting time for the job. The control unit 101 finds the best match between the experience level and location (at the job starting time) of the job seeker and the type of work and location of the posted job. In this embodiment, the control unit automatically sends a notice to both the job seeker and the job poster indicating that a suitable match can be made. In an embodiment, the control unit 101 also searches for mentorship opportunities, in which prospective mentors and mentees can be matched with each other.

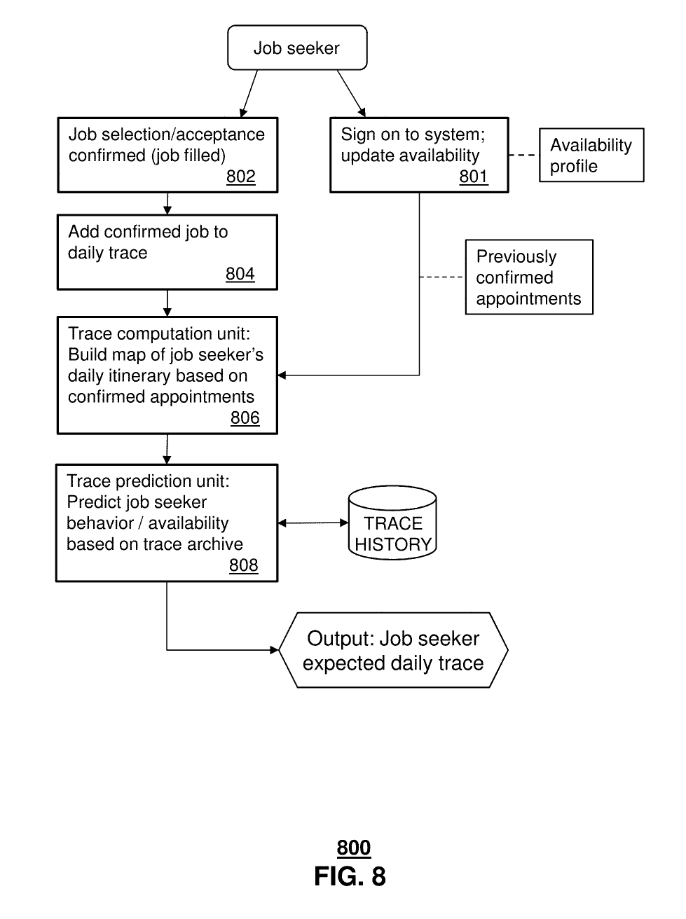

FIG. 8 is a flowchart illustrating a method 800 in which a job seeker's location is traced and predicted, in accordance with an embodiment of the disclosure. Tracing a job seeker through a day's movements can be triggered by the job seeker signing on to the system and updating his/her availability for work assignments (step 801). In an embodiment, the job seeker can load a default availability profile rather than entering an update. Alternatively, the method can be triggered by the job seeker confirming that s/he has an appointment to perform a job (step 802); the confirmed job is then added to the daily trace for the job seeker (step 804). The daily trace represents the job seeker's daily itinerary including events such as confirmed jobs, personal errands, or any other confirmed appointment.

The trace computation unit builds a map (step 806) of where the job seeker will be throughout the day, based on the job seeker's confirmed appointments (including any job accepted that day, as well as any previously confirmed appointments). The trace prediction unit then uses the trace history database (an archive of all known past job seeker traces) to predict the job seeker's behavior for times other than confirmed appointments (step 808). For example, if today is Wednesday and the job seeker in past weeks has not accepted a job on Wednesday afternoons, the trace prediction unit will indicate that the job seeker likely will be unavailable that afternoon. The system then can output the expected daily trace for the job seeker.

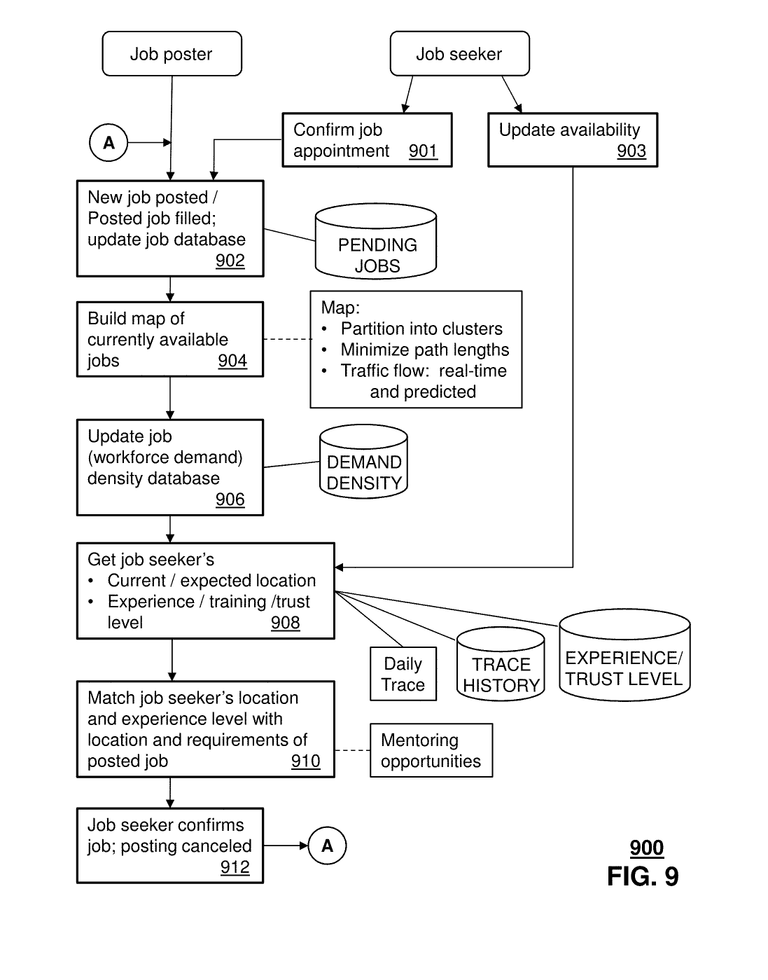

FIG. 9 is a flowchart illustrating a method 900 in which locations of jobs are mapped and matched with a job seeker's location, in accordance with an embodiment of the disclosure. Mapping the job locations can be triggered (step 902) by a job being added (a new job posting) or removed (a job poster canceling a job). Alternatively, the method can be triggered by the job seeker confirming that s/he has an appointment to perform a job (step 901).

The job location unit 131 builds a map of the currently available jobs (step 904). In this embodiment, this is done by the density mapping unit 740 using an algorithm that divides the geographical area of interest into blocks, partitions the available jobs (jobs starting within a predetermined time period) into clusters, minimizes path lengths connecting job locations, and predicts road traffic congestion along those paths. The density of available jobs (represented by a density of workforce demand) for the time period is stored in demand density database 136; this database is updated (step 906) when a job is newly posted or canceled.

In an embodiment, the map of currently available jobs is output to the mobile device 151 of the job seeker, along with the expected travel time based on the job seeker's present location. If the job seeker indicates (step 903) availability to perform a job appearing on the map, the system gets the job seeker's current location (or expected location at the start time of the job) and retrieves the job seeker's experience/training/trust level (step 908). The system then matches the job seeker with the job (step 910), based on the job requirements and the job seeker's qualifications and location. When the job seeker confirms his/her appointment for the job (step 912), the posting of that job is canceled, which in turn triggers an update to the jobs database and to the job mapping.

While for purposes of simplicity of explanation, the respective processes are shown and described as a series of blocks in FIGS. 3, 4, 6, 8 and 9, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

It will be appreciated that a process for compiling training resources according to various embodiments of the disclosure, examples of which are described herein, can be used in mobile communications including, but not limited to, fourth generation long term evolution (4G LTE) communications described in whole or in part by standards bodies such as Third Generation Partnership Project (3GPP). Embodiments of the disclosure may also be applicable to technologies evolving from 4G LTE, such as LTE Advanced (3GPP Release 10), LTE Advanced Pro (3GPP Release 13), and fifth generation radio access networks (5G RAN).

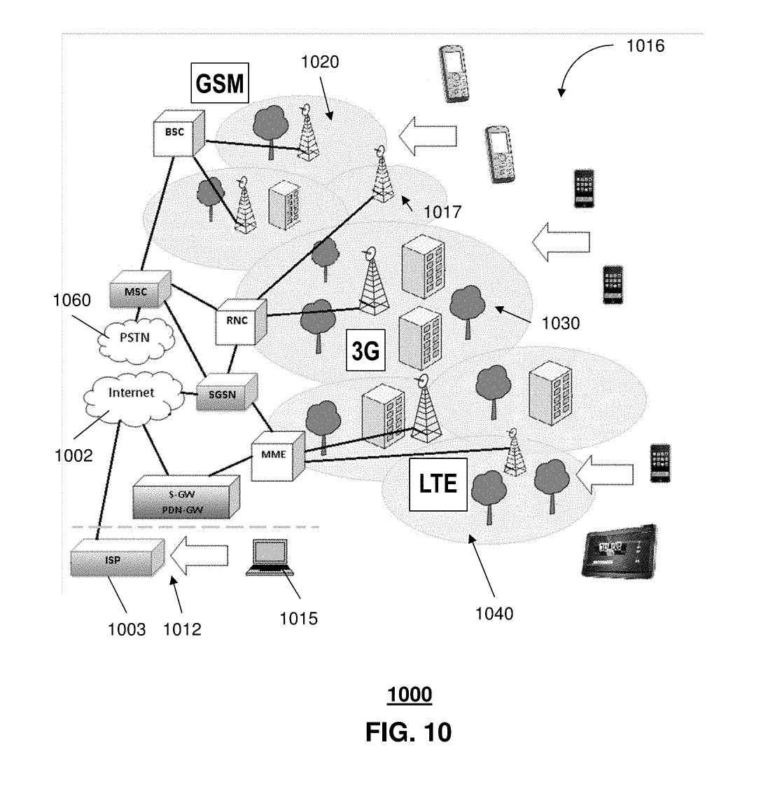

FIG. 10 depicts an illustrative embodiment of an architecture 1000 for a network for interacting with mobile communication devices. According to an embodiment of the disclosure, a mobile device 1016 (which may correspond to device 151) can connect with one or more of the networks shown in FIG. 10 using a personal credential and a mobile device gateway. Mobile device 1016 may be one of, but not limited to, a cellular telephone, a tablet, a cellular telephone in combination with another electronic device, or any other wireless mobile communication device. Mobile devices 1016 may represent a variety of technologies and may have an end-to-end connection established with either the Public Switched Telephone Network (PSTN) 1060, in the case of voice traffic, or an internet protocol network (Internet) 1002, in the case of data traffic. The architecture can include a Global System for Mobile (GSM) network 1020, a 3G network 1030, and/or a Long Term Evolution (LTE) network 1040. In particular, LTE specifications define an all-internet protocol architecture with voice over internet protocol (VoIP).

FIG. 10 also illustrates a device 1015 accessing the network through a broadband connection 1012 to an Internet Service Provider (ISP) 1003. Any of devices 1015-1016 can include a processing system including a processor and a memory that stores executable instructions that, when executed by the processing system, facilitate performance of operations. The operations can include receiving a description of a work assignment, where the description includes a keyword; searching online content for training material related to the work assignment; and searching the online content for information regarding the training material including a cost of the training material, trainee reviews, client reviews, and/or accreditations, at least a portion of the training material is accessible via a website. The operations can also include assigning a credibility ranking to the website; compiling a training material ranking in accordance with the information and the website credibility ranking; compiling the training material ranking further includes receiving survey data regarding previous use of the training material. The operations can further include generating a training program for performing the work assignment, based on the training material and the training material ranking, and storing training program data for facilitating access to the training program in a training program database; the training program database is indexed using the keyword.

FIG. 11 depicts an illustrative embodiment of a communication system 1100 employing an IP Multimedia Subsystem (IMS) network architecture to facilitate the combined services of circuit-switched and packet-switched systems.

Communication system 1100 can be overlaid or operably coupled with systems 100 and/or 1000 as another representative embodiment. In particular, system 1100 when operably coupled with systems 100, 1000 and/or 1100 can facilitate performance of a method including receiving, by a processing system including a processor, a description of a work assignment; the description includes a keyword. The method can also include searching online content for training material related to the work assignment, and searching the online content for information regarding the training material including a cost of the training material, trainee reviews, client reviews, and/or accreditations; at least a portion of the training material is accessible via a website. The method can also include assigning a credibility ranking to the website; compiling a training material ranking in accordance with the information and the website credibility ranking; and generating a training program for performing the work assignment, based on the training material and the training material ranking. The method can further include storing training program data for facilitating access to the training program in a training program database, where the training program database is indexed using the keyword.

Communication system 1100 can comprise a Home Subscriber Server (HSS) 1140, a tElephone NUmber Mapping (ENUM) server 1130, and other network elements of an IMS network 1150. The IMS network 1150 can establish communications between IMS-compliant communication devices (CDs) 1101, 1102, Public Switched Telephone Network (PSTN) CDs 1103, 1105, and combinations thereof by way of a Media Gateway Control Function (MGCF) 1120 coupled to a PSTN network 1160. The MGCF 1120 need not be used when a communication session involves IMS CD to IMS CD communications. A communication session involving at least one PSTN CD may utilize the MGCF 1120.

IMS CDs 1101, 1102 can register with the IMS network 1150 by contacting a Proxy Call Session Control Function (P-CSCF) which communicates with an interrogating CSCF (I-CSCF), which in turn, communicates with a Serving CSCF (S-CSCF) to register the CDs with the HSS 1140. To initiate a communication session between CDs, an originating IMS CD 1101 can submit a Session Initiation Protocol (SIP INVITE) message to an originating P-CSCF 1104 which communicates with a corresponding originating S-CSCF 1106. The originating S-CSCF 1106 can submit the SIP INVITE message to one or more application servers (ASs) 1117 that can provide a variety of services to IMS subscribers.

For example, the application servers 1117 can be used to perform originating call feature treatment functions on the calling party number received by the originating S-CSCF 1106 in the SIP INVITE message. Originating treatment functions can include determining whether the calling party number has international calling services, call ID blocking, calling name blocking, 7-digit dialing, and/or is requesting special telephony features (e.g., *72 forward calls, *73 cancel call forwarding, *67 for caller ID blocking, and so on). Based on initial filter criteria (iFCs) in a subscriber profile associated with a CD, one or more application servers may be invoked to provide various call originating feature services.

Additionally, the originating S-CSCF 1106 can submit queries to the ENUM system 1130 to translate an E.164 telephone number in the SIP INVITE message to a SIP Uniform Resource Identifier (URI) if the terminating communication device is IMS-compliant. The SIP URI can be used by an Interrogating CSCF (I-CSCF) 1107 to submit a query to the HSS 1140 to identify a terminating S-CSCF 1114 associated with a terminating IMS CD such as reference 1102. Once identified, the I-CSCF 1107 can submit the SIP INVITE message to the terminating S-CSCF 1114. The terminating S-CSCF 1114 can then identify a terminating P-CSCF 1116 associated with the terminating CD 1102. The P-CSCF 1116 may then signal the CD 1102 to establish Voice over Internet Protocol (VoIP) communication services, thereby enabling the calling and called parties to engage in voice and/or data communications. Based on the iFCs in the subscriber profile, one or more application servers may be invoked to provide various call terminating feature services, such as call forwarding, do not disturb, music tones, simultaneous ringing, sequential ringing, etc.

In some instances the aforementioned communication process is symmetrical. Accordingly, the terms “originating” and “terminating” in FIG. 11 may be interchangeable. It is further noted that communication system 1100 can be adapted to support video conferencing. In addition, communication system 1100 can be adapted to provide the IMS CDs 1101, 1102 with the Internet services of communication system 1100 of FIG. 11.

If the terminating communication device is instead a PSTN CD such as CD 1103 or CD 1105 (in instances where the cellular phone only supports circuit-switched voice communications), the ENUM system 1130 can respond with an unsuccessful address resolution which can cause the originating S-CSCF 1106 to forward the call to the MGCF 1120 via a Breakout Gateway Control Function (BGCF) 1119. The MGCF 1120 can then initiate the call to the terminating PSTN CD over the PSTN network 1160 to enable the calling and called parties to engage in voice and/or data communications.

It is further appreciated that the CDs of FIG. 11 can operate as wireline or wireless devices. For example, the CDs of FIG. 11 can be communicatively coupled to a cellular base station 1121, a femtocell, a WiFi router, a Digital Enhanced Cordless Telecommunications (DECT) base unit, or another suitable wireless access unit to establish communications with the IMS network 1150 of FIG. 11. The cellular access base station 1121 can operate according to common wireless access protocols such as GSM, CDMA, TDMA, UMTS, WiMax, SDR, LTE, and so on. Other present and next generation wireless network technologies can be used by one or more embodiments of the subject disclosure. Accordingly, multiple wireline and wireless communication technologies can be used by the CDs of FIG. 11.

Cellular phones supporting LTE can support packet-switched voice and packet-switched data communications and thus may operate as IMS-compliant mobile devices. In this embodiment, the cellular base station 1121 may communicate directly with the IMS network 1150 as shown by the arrow connecting the cellular base station 1121 and the P-CSCF 1116.

Alternative forms of a CSCF can operate in a device, system, component, or other form of centralized or distributed hardware and/or software. Indeed, a respective CSCF may be embodied as a respective CSCF system having one or more computers or servers, either centralized or distributed, where each computer or server may be configured to perform or provide, in whole or in part, any method, step, or functionality described herein in accordance with a respective CSCF. Likewise, other functions, servers and computers described herein, including but not limited to, the HSS, the ENUM server, the BGCF, and the MGCF, can be embodied in a respective system having one or more computers or servers, either centralized or distributed, where each computer or server may be configured to perform or provide, in whole or in part, any method, step, or functionality described herein in accordance with a respective function, server, or computer.

For illustration purposes only, the terms S-CSCF, P-CSCF, I-CSCF, and so on, can be server devices, but may be referred to in the subject disclosure without the word “server.” It is also understood that any form of a CSCF server can operate in a device, system, component, or other form of centralized or distributed hardware and software. It is further noted that these terms and other terms such as DIAMETER commands are terms can include features, methodologies, and/or fields that may be described in whole or in part by standards bodies such as Third Generation Partnership Project (3GPP). It is further noted that some or all embodiments of the subject disclosure may in whole or in part modify, supplement, or otherwise supersede final or proposed standards published and promulgated by 3GPP.

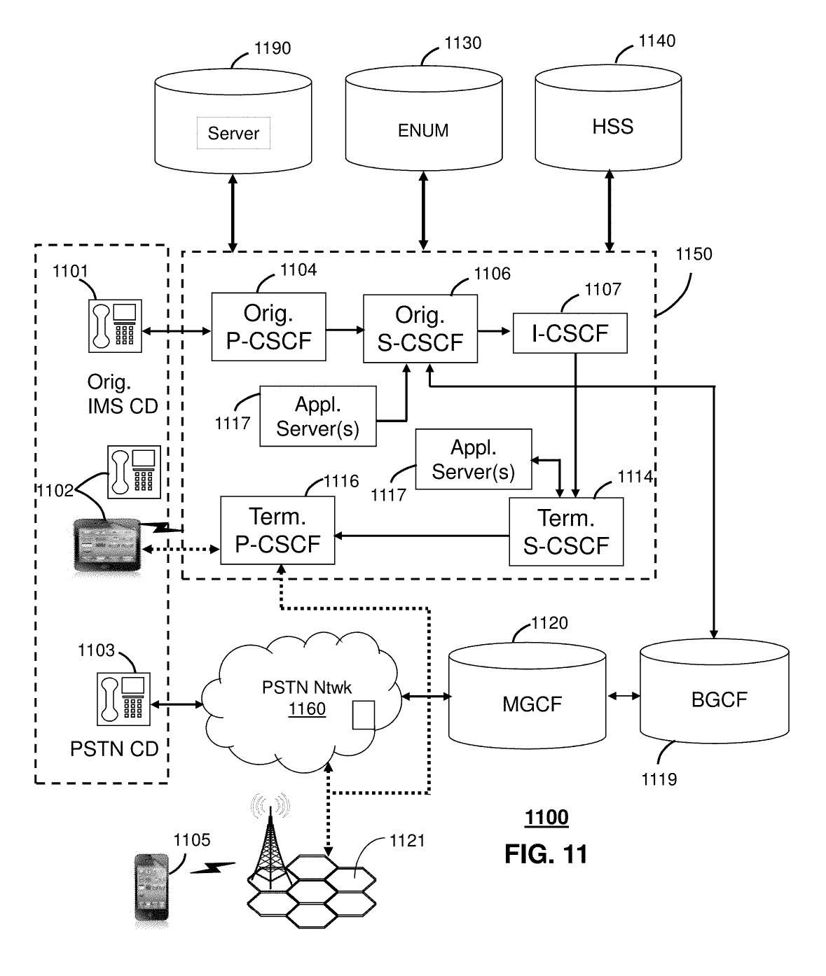

FIG. 12 depicts an illustrative embodiment of a web portal 1202 of a communication system 1200. Communication system 1200 can be overlaid or operably coupled with communication systems 1000-1100 as another representative embodiment of a system for building a training program as shown in FIGS. 1-4. The web portal 1202 can be used for managing services of communication systems 100 and/or 1000. A web page of the web portal 1202 can be accessed by a Uniform Resource Locator (URL) with an Internet browser using an Internet-capable communication device such as those described in FIGS. 10-11. The web portal 1202 can be configured, for example, to access UE 1102; in an embodiment, UE 1102 comprises a media processor and services managed thereby such as a Digital Video Recorder (DVR), a Video on Demand (VoD) catalog, an Electronic Programming Guide (EPG), or a personal catalog (such as personal videos, pictures, audio recordings, etc.) stored at the media processor. The web portal 1202 can also be used for provisioning IMS services described earlier, provisioning Internet services, provisioning cellular phone services, and so on.

The web portal 1202 can further be utilized to manage and provision software applications to adapt these applications as may be desired by subscribers and/or service providers of communication systems 1000-1100. For instance, users of services provided over networks shown in FIGS. 10-11 can log into their on-line accounts and provision server 1163 or 1140 with user profiles or contact information to the server to enable communication with devices described in FIGS. 10 and 11, and so on. Service providers can log onto an administrator account to provision, monitor and/or maintain the systems of FIGS. 10 and 11.

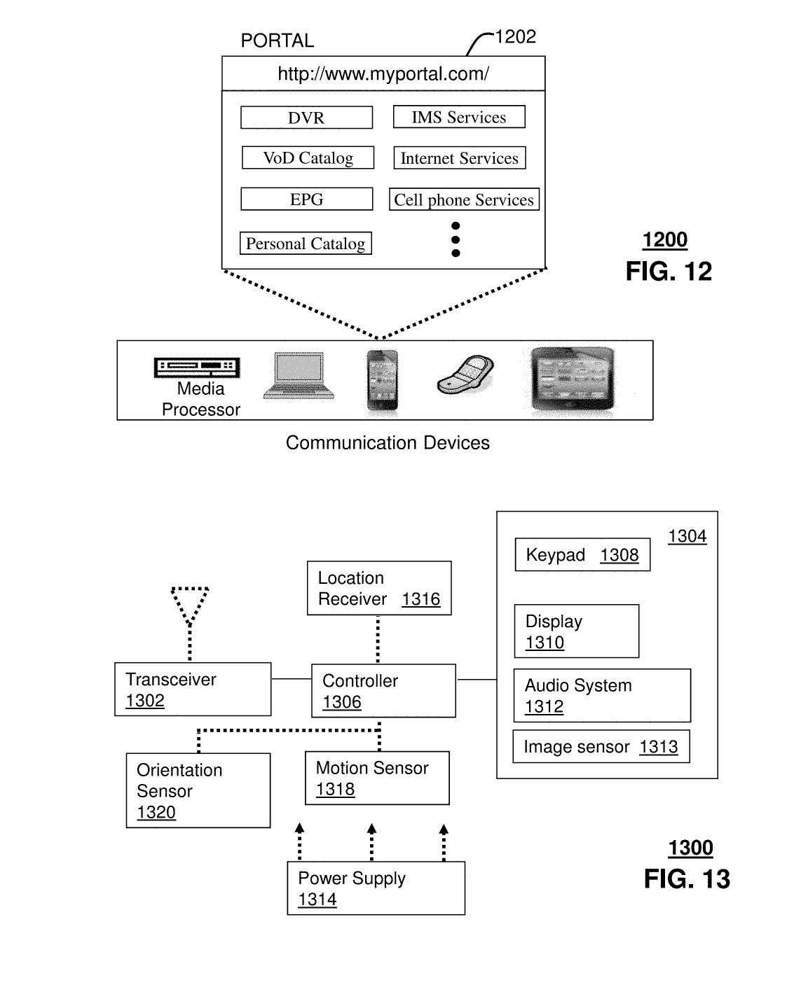

FIG. 13 depicts an illustrative embodiment of a communication device 1300. Communication device 1300 can serve in whole or in part as an illustrative embodiment of the devices depicted in FIGS. 10 and 11, and can be configured to perform portions of methods 300, 400, 600, 800 or 900.

Communication device 1300 can comprise a wireline and/or wireless transceiver 1302 (herein transceiver 1302), a user interface (UI) 1304, a power supply 1314, a location receiver 1316, a motion sensor 1318, an orientation sensor 1320, and a controller 1306 for managing operations thereof. The transceiver 1302 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 1302 can also be adapted to support circuit-switched wireline access technologies (such as PSTN), packet-switched wireline access technologies (such as TCP/IP, VoIP, etc.), and combinations thereof.

The UI 1304 can include a depressible or touch-sensitive keypad 1308 with a navigation mechanism such as a roller ball, a joystick, a mouse, or a navigation disk for manipulating operations of the communication device 1300. The keypad 1308 can be an integral part of a housing assembly of the communication device 1300 or an independent device operably coupled thereto by a tethered wireline interface (such as a USB cable) or a wireless interface supporting for example Bluetooth®. The keypad 1308 can represent a numeric keypad commonly used by phones, and/or a QWERTY keypad with alphanumeric keys. The UI 1304 can further include a display 1310 such as monochrome or color LCD (Liquid Crystal Display), OLED (Organic Light Emitting Diode) or other suitable display technology for conveying images to an end user of the communication device 1300. In an embodiment where the display 1310 is touch-sensitive, a portion or all of the keypad 1308 can be presented by way of the display 1310 with navigation features.

The display 1310 can use touch screen technology to also serve as a user interface for detecting user input. As a touch screen display, the communication device 1300 can be adapted to present a user interface with graphical user interface (GUI) elements that can be selected by a user with a touch of a finger. The touch screen display 1310 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 1310 can be an integral part of the housing assembly of the communication device 1300 or an independent device communicatively coupled thereto by a tethered wireline interface (such as a cable) or a wireless interface.

The UI 1304 can also include an audio system 1312 that utilizes audio technology for conveying low volume audio (such as audio heard in proximity of a human ear) and high volume audio (such as speakerphone for hands free operation). The audio system 1312 can further include a microphone for receiving audible signals of an end user. The audio system 1312 can also be used for voice recognition applications. The UI 1304 can further include an image sensor 1313 such as a charged coupled device (CCD) camera for capturing still or moving images.

The power supply 1314 can utilize common power management technologies such as replaceable and rechargeable batteries, supply regulation technologies, and/or charging system technologies for supplying energy to the components of the communication device 1300 to facilitate long-range or short-range portable applications. Alternatively, or in combination, the charging system can utilize external power sources such as DC power supplied over a physical interface such as a USB port or other suitable tethering technologies.

The location receiver 1316 can utilize location technology such as a global positioning system (GPS) receiver capable of assisted GPS for identifying a location of the communication device 1300 based on signals generated by a constellation of GPS satellites, which can be used for facilitating location services such as navigation. The motion sensor 1318 can utilize motion sensing technology such as an accelerometer, a gyroscope, or other suitable motion sensing technology to detect motion of the communication device 1300 in three-dimensional space. The orientation sensor 1320 can utilize orientation sensing technology such as a magnetometer to detect the orientation of the communication device 1300 (north, south, west, and east, as well as combined orientations in degrees, minutes, or other suitable orientation metrics).

The communication device 1300 can use the transceiver 1302 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 1306 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 1300.

Other components not shown in FIG. 13 can be used in one or more embodiments of the subject disclosure. For instance, the communication device 1300 can include a reset button (not shown). The reset button can be used to reset the controller 1306 of the communication device 1300. In yet another embodiment, the communication device 1300 can also include a factory default setting button positioned, for example, below a small hole in a housing assembly of the communication device 1300 to force the communication device 1300 to re-establish factory settings. In this embodiment, a user can use a protruding object such as a pen or paper clip tip to reach into the hole and depress the default setting button. The communication device 1300 can also include a slot for adding or removing an identity module such as a Subscriber Identity Module (SIM) card. SIM cards can be used for identifying subscriber services, executing programs, storing subscriber data, and so forth.

The communication device 1300 as described herein can operate with more or less of the circuit components shown in FIG. 13. These variant embodiments can be used in one or more embodiments of the subject disclosure.

The communication device 1300 can be adapted to perform the functions of UE devices of FIG. 1, the portable communication devices 1016 of FIG. 10, and the mobile station 1101 and UE 1102 of FIG. 11, as well as the IMS CDs 1101-1102 and PSTN CDs 1103-1105 of FIG. 11. It will be appreciated that the communication device 1300 can also represent other devices that can operate in communication systems 1000-1100 of FIGS. 10-11. In addition, the controller 1306 can be adapted in various embodiments for searching and compiling training material for building a training program.

Upon reviewing the aforementioned embodiments, it would be evident to an artisan with ordinary skill in the art that said embodiments can be modified, reduced, or enhanced without departing from the scope of the claims described below. For example, a computing device including a processor can be configured to build a list of job seekers in a geographical area whose trust levels vary with subject area and dynamically change as work assignments are completed. Other embodiments can be used in the subject disclosure.

In addition, it will be appreciated that one or more of the embodiments can be performed without user interaction. For example, dynamically listing available jobs within a certain distance from the job seeker's present or expected location; tracing and mapping the job seeker's movements; informing a job provider and/or mentor that a training program has been completed, etc. are automated in various embodiments and do not require user input or user interaction.

It should be understood that devices described in the exemplary embodiments can be in communication with each other via various wireless and/or wired methodologies. The methodologies can be links that are described as coupled, connected and so forth, which can include unidirectional and/or bidirectional communication over wireless paths and/or wired paths that utilize one or more of various protocols or methodologies, where the coupling and/or connection can be direct (e.g., no intervening processing device) and/or indirect (e.g., an intermediary processing device such as a router).

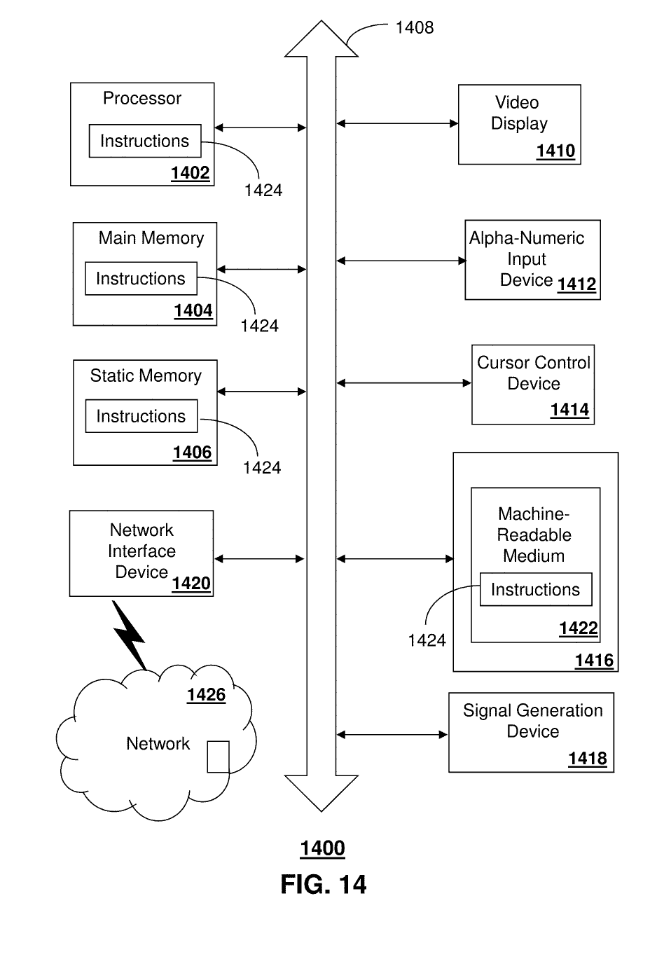

FIG. 14 depicts an exemplary diagrammatic representation of a machine in the form of a computer system 1400 within which a set of instructions, when executed, may cause the machine to perform any one or more of the methods described above. One or more instances of the machine can operate, for example, as a processing system that generates a training program in a given subject area based on a search using keywords provided by a job provider and/or a job seeker. In some embodiments, the machine may be connected (e.g., using a network 1426) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 1400 may include a processor (or controller) 1402 (e.g., a central processing unit (CPU)), a graphics processing unit (GPU, or both), a main memory 1404 and a static memory 1406, which communicate with each other via a bus 1408. The computer system 1400 may further include a display unit 1410 (e.g., a liquid crystal display (LCD), a flat panel, or a solid state display). The computer system 1400 may include an input device 1412 (e.g., a keyboard), a cursor control device 1414 (e.g., a mouse), a disk drive unit 1416, a signal generation device 1418 (e.g., a speaker or remote control) and a network interface device 1420. In distributed environments, the embodiments described in the subject disclosure can be adapted to utilize multiple display units 1410 controlled by two or more computer systems 1400. In this configuration, presentations described by the subject disclosure may in part be shown in a first of the display units 1410, while the remaining portion is presented in a second of the display units 1410.

The disk drive unit 1416 may include a tangible computer-readable storage medium 1422 on which is stored one or more sets of instructions (e.g., software 1424) embodying any one or more of the methods or functions described herein, including those methods illustrated above. The instructions 1424 may also reside, completely or at least partially, within the main memory 1404, the static memory 1406, and/or within the processor 1402 during execution thereof by the computer system 1400. The main memory 1404 and the processor 1402 also may constitute tangible computer-readable storage media.

Dedicated hardware implementations including, but not limited to, application specific integrated circuits, programmable logic arrays and other hardware devices can likewise be constructed to implement the methods described herein. Application specific integrated circuits and programmable logic array can use downloadable instructions for executing state machines and/or circuit configurations to implement embodiments of the subject disclosure. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the subject disclosure, the operations or methods described herein are intended for operation as software programs or instructions running on or executed by a computer processor or other computing device, and which may include other forms of instructions manifested as a state machine implemented with logic components in an application specific integrated circuit or field programmable gate array. Furthermore, software implementations (e.g., software programs, instructions, etc.) including, but not limited to, distributed processing or component/object distributed processing, parallel processing, or virtual machine processing can also be constructed to implement the methods described herein. Distributed processing environments can include multiple processors in a single machine, single processors in multiple machines, and/or multiple processors in multiple machines. It is further noted that a computing device such as a processor, a controller, a state machine or other suitable device for executing instructions to perform operations or methods may perform such operations directly or indirectly by way of one or more intermediate devices directed by the computing device.

While the tangible computer-readable storage medium 1422 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the subject disclosure. The term “non-transitory” as in a non-transitory computer-readable storage includes without limitation memories, drives, devices and anything tangible but not a signal per se.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth®, WiFi, Zigbee®), and long-range communications (e.g., WiMAX, GSM, CDMA, LTE) can be used by computer system 1400. In one or more embodiments, information regarding use of services can be generated including services being accessed, media consumption history, user preferences, and so forth. This information can be obtained by various methods including user input, detecting types of communications (e.g., video content vs. audio content), analysis of content streams, and so forth. The generating, obtaining and/or monitoring of this information can be responsive to an authorization provided by the user.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. The exemplary embodiments can include combinations of features and/or steps from multiple embodiments. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

Less than all of the steps or functions described with respect to the exemplary processes or methods can also be performed in one or more of the exemplary embodiments. Further, the use of numerical terms to describe a device, component, step or function, such as first, second, third, and so forth, is not intended to describe an order or function unless expressly stated so. The use of the terms first, second, third and so forth, is generally to distinguish between devices, components, steps or functions unless expressly stated otherwise. Additionally, one or more devices or components described with respect to the exemplary embodiments can facilitate one or more functions, where the facilitating (e.g., facilitating access or facilitating establishing a connection) can include less than every step needed to perform the function or can include all of the steps needed to perform the function.

In one or more embodiments, a processor (which can include a controller or circuit) has been described that performs various functions. It should be understood that the processor can be multiple processors, which can include distributed processors or parallel processors in a single machine or multiple machines. The processor can be used in supporting a virtual processing environment. The virtual processing environment may support one or more virtual machines representing computers, servers, or other computing devices. In such virtual machines, components such as microprocessors and storage devices may be virtualized or logically represented. The processor can include a state machine, application specific integrated circuit, and/or programmable gate array including a Field PGA. In one or more embodiments, when a processor executes instructions to perform “operations”, this can include the processor performing the operations directly and/or facilitating, directing, or cooperating with another device or component to perform the operations.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, comprising:
receiving, by a processing system including a processor, a description of a work assignment, the description including a keyword and information regarding the work assignment including a location of the work assignment, a starting time of the work assignment, a completion deadline of the work assignment, or a combination thereof;
searching, by the processing system, electronically accessible content for training material related to the work assignment;
searching, by the processing system, the content for information regarding the training material including a cost of the training material, trainee reviews, client reviews, accreditations, or a combination thereof, wherein at least a portion of the training material is accessible via a website;
assigning, by the processing system, a credibility ranking to the website;
determining, by the processing system, a training material ranking in accordance with the information and the website credibility ranking;
generating, by the processing system, a training program for performing the work assignment based on the training material and the training material ranking, wherein at least a portion of the training material comprises material offered for online purchase, and wherein at least a portion of the information regarding the training material is publicly available free of charge; and
storing, by the processing system, training program data for facilitating access to the training program in a training program database, wherein the training program database is indexed using the keyword.

2. The method of claim 1, wherein the description of the work assignment is received in an inquiry from equipment of a candidate for performing the work assignment, and further comprising:
delivering, by the processing system, to the equipment of the candidate the training program data for facilitating access to the training program, wherein the training program data is delivered at least a predetermined interval in advance of the starting time of the work assignment and responsive to the equipment of the candidate being located within a predetermined distance from the location of the work assignment.

3. The method of claim 2, further comprising:
receiving, by the processing system, a message from the equipment of the candidate regarding completion of the training program; and
updating, by the processing system, an experience database having information relating to the candidate including experience, training, a trust level, or a combination thereof.

4. The method of claim 1, wherein the training program is generated using items of training material associated with training material rankings satisfying a predetermined ranking threshold.

5. The method of claim 1, wherein the determining the training material ranking further comprises receiving survey data regarding previous use of the training material.

6. The method of claim 1, wherein the description of the work assignment is received in a message from equipment of a job provider offering the work assignment, wherein the message includes information regarding requirements for performing the work assignment, and further comprising:
storing, by the processing system, the description of the work assignment and the information regarding the requirements in a job database;
receiving, by the processing system, an inquiry from equipment of a candidate for performing the work assignment;
retrieving, by the processing system, information relating to the candidate including experience, training, a trust level, or a combination thereof; and
determining, by the processing system, whether the candidate is qualified to perform the work assignment based on the information regarding the requirements and the information relating to the candidate.

7. The method of claim 6, wherein the information regarding the requirements comprises an identifier of the training program, and wherein the determining comprises determining whether the candidate has completed the training program.

8. The method of claim 1, further comprising;
generating, by the processing system, information regarding a mentoring session relating to the work assignment; and
delivering, by the processing system, the information regarding the mentoring session to equipment of a candidate for performing the work assignment.

9. The method of claim 8, further comprising:
receiving, by the processing system, a message from the equipment of the candidate regarding completion of the mentoring session; and
updating, by the processing system, an experience database having information relating to the candidate including experience, training, a trust level, or a combination thereof.

10. The method of claim 1, further comprising:
transmitting, by the processing system, a map of locations of available work assignments for display at equipment of a candidate for performing the work assignment.

11. A device comprising:
a processing system including a processor; and
a memory that stores executable instructions that, when executed by the processing system, facilitate performance of operations, comprising:
receiving a description of a work assignment, the description including a keyword and information regarding the work assignment including a location of the work assignment, a starting time of the work assignment, a completion deadline of the work assignment, or a combination thereof;
searching electronically accessible content for training material related to the work assignment;
searching the content for information regarding the training material including a cost of the training material, trainee reviews, client reviews, accreditations, or a combination thereof, wherein at least a portion of the training material is accessible via a website;
assigning a credibility ranking to the website;
determining a training material ranking in accordance with the information and the website credibility ranking;
generating a training program for performing the work assignment, based on the training material and the training material ranking, wherein at least a portion of the training material comprises material offered for online purchase, and wherein at least a portion of the information regarding the training material is publicly available free of charge; and
storing training program data for facilitating access to the training program in a training program database, wherein the training program database is indexed using the keyword,
wherein the description of the work assignment includes information regarding requirements for performing the work assignment, and wherein the information regarding the requirements comprises an identifier of the training program.

12. The device of claim 11, wherein the operations further comprise:
receiving an inquiry from equipment of a candidate for performing the work assignment; and
delivering to the equipment of the candidate the training program data for facilitating access to the training program, wherein the training program data is delivered at least a predetermined interval in advance of the starting time of the work assignment and responsive to the equipment of the candidate being located within a predetermined distance from the location of the work assignment.

13. The device of claim 12, wherein the operations further comprise:
receiving a message from the equipment of the candidate regarding completion of the training program; and
updating an experience database having information relating to the candidate including experience, training, a trust level, or a combination thereof.

14. The device of claim 11, wherein the training program is generated using items of training material associated with training material rankings satisfying a predetermined ranking threshold.

15. The device of claim 11, wherein the determining the training material ranking further comprises receiving survey data regarding previous use of the training material.

16. A machine-readable storage medium, comprising executable instructions that, when executed by a processing system including a processor, facilitate performance of operations comprising:
receiving a description of a work assignment, the description including a keyword;
searching electronically accessible content for training material related to the work assignment;
searching the content for information regarding the training material including a cost of the training material, trainee reviews, client reviews, accreditations, or a combination thereof, wherein at least a portion of the training material is accessible via a website;
assigning a credibility ranking to the website;
determining a training material ranking in accordance with the information and the website credibility ranking, wherein determining the training material ranking further comprises receiving survey data regarding previous use of the training material;
generating a training program for performing the work assignment, based on the training material and the training material ranking, wherein at least a portion of the training material comprises material offered for online purchase, and wherein at least a portion of the information regarding the training material is publicly available free of charge; and
storing training program data for facilitating access to the training program in a training program database, wherein the training program database is indexed using the keyword.

17. The machine-readable storage medium of claim 16, wherein the operations further comprise:
receiving an inquiry from equipment of a candidate for performing the work assignment; and
delivering to the equipment of the candidate the training program data for facilitating access to the training program, wherein the training program data is delivered at least a predetermined interval in advance of the starting time of the work assignment and responsive to the equipment of the candidate being located within a predetermined distance from the location of the work assignment.

18. The machine-readable storage medium of claim 17, wherein the operations further comprise:
receiving a message from the equipment of the candidate regarding completion of the training program; and
updating an experience database having information relating to the candidate including experience, training, a trust level, or a combination thereof.

19. The machine-readable storage medium of claim 16, wherein the training program is generated using items of training material associated with training material rankings satisfying a predetermined ranking threshold.

20. The machine-readable storage medium of claim 16, wherein the description of the work assignment includes information regarding requirements for performing the work assignment, and wherein the information regarding the requirements comprises an identifier of the training program.
